(19) United States
(12) Patent Application Publication
(10) Pub. No.: US 2012/0073514 A1
(43) Pub. Date: Mar. 29, 2012

(54) Pet toy containing durable squeaking device

(75) Inventor: Kyle Hansen, Castle Rock, CO (US)

(73) Assignee: The Kyjen Company, Inc.

(21) Appl. No.: 12/924,480

(22) Filed: Sep. 28, 2010

(51) Int. Cl. A01K 15/02; A01K 29/00

(52) U.S. Cl. 119/707

(57) ABSTRACT

The invention relates to a squeaking pet toy that is designed to continue to emit sound even if an animal has punctured the squeaker mechanism. The double-lipped reed tube design of the pet toy is novel in shape and prevents breakage of the reed tube or slippage into the toy air chamber which would eliminate the toy's ability to emit sound. The inventive toy is encased in a plush type animal shaped cover for pet enticement.

### FIELD

The invention relates to a novel pet toy wherein the toy contains a squeaking device (squeaker), or a plurality of squeaking devices, which, when chewed upon by an animal, emits a squeaking sound and will continue to do so even if punctured. The toy is encased in a plush type animal shape such as a snake, alligator or the like to aid in enticement of the animal.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel method of providing a durable squeaker within a pet toy wherein the novelty is that the toy will continue to emit sound even if the animal has puncture one or more of the squeaking devices therein. A second novelty is the reed tube design which aids in the prevention of breakage or slippage of the reed tube, and thus again, the loss of sound emission.

Current pet toys contain squeaker devices; however, none in the art claim continued sound emission after puncture by an animal. Application 20050066911 (Lubeck, Amy) discloses a dog squeaker toy which contains a squeaker device within a tennis ball tug toy. The novelty claimed by Lubeck is that the squeaker is mounted within the framework of the tug toy in such a way that it cannot be punctured [0018]. The Lubeck invention protects the squeaker simply by the nature of the material of the ball housing, i.e. its thickness. This does not provide for the continuance of sound emissions in the event that the squeaker is punctured. Such encasement material would indeed diminish and ultimately the squeaker would be punctured and rendered useless for sound emission.

### THE INVENTION

Summary, Objects and Advantages

Pet toys are in obvious abundance in this and other countries. There are pet toys which make sounds, and there are pet toys which dispense treats upon engagement of the pet's conditioning. The problem with sound emitting pet toys specifically is that when the animal damages the sound device, the toy ceases to work and ceases to engage the animal. In the current art, the squeaking toys specifically lack the technology to provide continued squeaking if the squeaker device is punctured. Thus, the toy is of little use to the pet owner or pet if damaged.

The inventive pet toy has two main novel aspects. One is the reed tube system, common to squeaking toys, and the design of the air chamber from which the sound is emitted. In current art, the reed portions of squeaker toys utilize a one-piece tube and chamber design which animals can easily sever which causes the reed portion to fall into the air chamber and disable the ability to produce sound. Another issue with the present art reed portions is that an animal can simply bite and break the entire reed tube which disables its ability to produce sound.

The inventive pet toy utilizes a double-lipped reed tube mechanism wherein there are two lips on the reed tube itself The first larger lip allows intake of air and disallows the reed tube to slip inside the air chamber. The second smaller lip inserts into the air chamber opening and disallows it to easily slip out of the air chamber. Inside the tube is a traditional vibrating reed squeaker. The mechanism is inserted into the air chamber such that it makes it less likely the animal can break the reed tube. This mechanism is then inserted into the air chamber and eliminates the possibility of very aggressive animals severing the reed tube from the chamber or it being broken by the animal's bite and slipping into the air chamber.

The second area of novelty in the inventive toy is the air chamber itself The air chamber is designed such that if punctured by a canine tooth, for example, the volume and resistance of the reed tube to air flow is such that the air intake and release are balanced to effect continuance of sound production.

In summary, the inventive pet toy exhibits advantages and novelty over the art in that the design and functionality make this pet toy durable and a value for the consumer since the toy will continue to perform as advertised under rough conditions of pet play.

### BRIEF DESCRIPTION OF THE DRAWINGS

The invention is described in further detail by reference to the drawings in which:

FIG. 1; depicts a view of the double-lip reed tube.

FIG. 2; illustrates the position of insertion into the air chamber.

FIG. 3; is a view of the air chamber with the reed tube assembly inserted.

FIG. 4; is illustrative of the air emission process past puncture; and

FIG. 5; illustrates the inventive reed tube and air chambers as encased within an animal shape.

### DETAILED DESCRIPTION, INCLUDING BEST MODES OF CARRYING OUT THE INVENTION

The following detailed description illustrates the invention by way of example, not by way of limitation of the principles of the invention. This description will clearly enable one skilled in the art to make and use the invention, and describes various embodiments, adaptations, variations, alternatives, and uses of the invention. The description includes what are presently believed to be the best modes of carrying out the invention.

In this regard, the invention is illustrated in five relatively simple figures; although sufficiently complex as to illuminate to one skilled in the art of such software architecture, programming, and computer operations a viable method for making or using said invention.

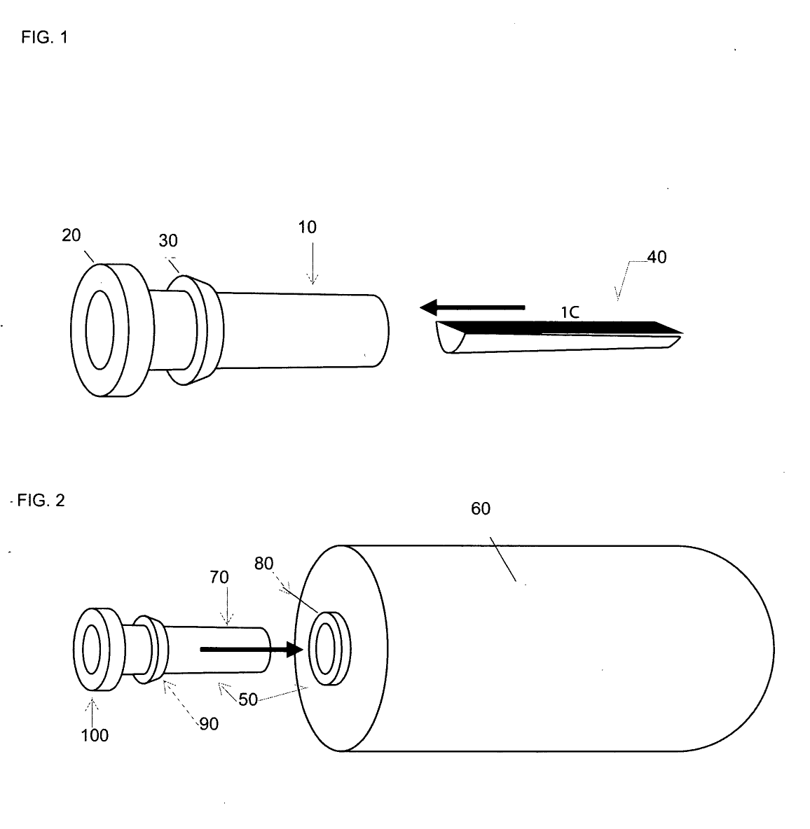

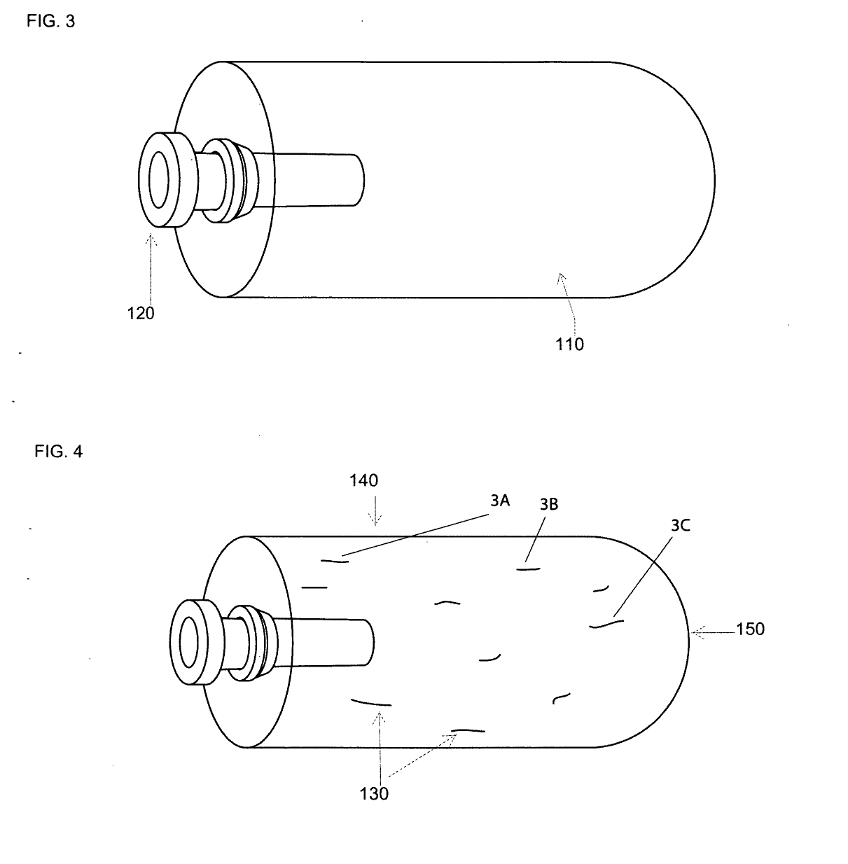

FIG. 1 depicts the double-lipped reed tube 10. A first larger lip 20 is located on the intake portion of the reed tube. A second lip 30 is located further down on the tube so as to effect connection with the air chamber of FIG. 2. The reed tube is inserted into a receiving lip on the air chamber as shown in FIG. 2. Also shown is a traditional vibrating squeaker 40 which is contained within the double tube mechanism. Such construction aids in the prevention of breakage of the reed tube and slippage of same into the air chamber causing disablement of the reed and failure of sound emission.

FIG. 2 is a simple illustration of the dual reed tube mechanism 50 and its relationship to the air chamber 60. The reed tube 70 is firmly inserted into the air chamber opening 80 and securely glued or affixed. The second lip 90 inserts into the air chamber such that it cannot easily be removed. The first lip of the reed tube 100 is sized so that the reed tube mechanism cannot fall inside the air chamber, thus making sound emissions impossible.

FIG. 3 is a view of the air chamber 110 with the double reed tube 120 installed and is primarily for illustrative purposes as the connection method is fairly evident.

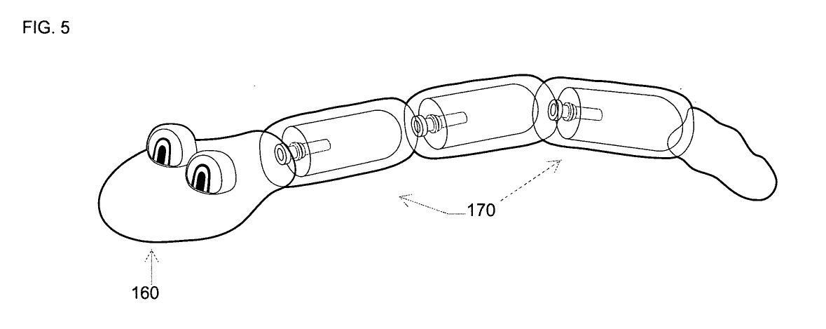

FIG. 4 illustrates the novel feature of sound emission post puncture. Sample slits 130 are shown as penetrating the air chamber 140. We can assume that a dog has chewed aggressively into the outer plush encasement of the toy and has punctured the air chamber. The cylindrical shape of the air chamber is capped by a sphere 150 which disperses force evenly such as in an arch force wherein statics, or balanced forces are achieved. Thus the pressure from the intake air and the emission air is the same within the chamber and will tend to seal the slits 130 as opposed to expanding their apertures. This is a result of the statics force being even along the surface walls of the chamber resulting from the shape of the chamber. Even larger slits, while not well sealed in this mechanism, will still force a sufficient volume of air through the reed to emit sound.

FIG. 5 is an illustration of the inventive reed tube mechanism and air chamber as encased within the aforementioned plush-type animal body 160. FIG. 5 obviously depicts a snake with multiple of the inventive mechanisms inserted into body cavity sections of the snake 170.

1) A squeaking pet toy containing:
a) a double-lipped reed tube
b) an arch shaped air chamber
c) a vibrating reed squeaker housed within the reed tube
d) an outer encasement enclosing the reed tube and chamber

2) The squeaking pet toy of claim 1 wherein the double-lipped reed tube is comprised of a larger lip on the opening air intake end, and a smaller lip on the reed tube located slightly further down from said large lip.

3) The squeaking pet toy of claim 1 wherein the air chamber is cylindrical in shape with an arch at one end for statics force enablement.

4) The squeaking pet toy of claim 1 wherein the air chamber shape results in emission of squeaking sounds even if punctured.

5) The squeaking pet toy of claim 1 wherein a vibrating reed squeaker is housed within the double-lipped reed tube.

6) The squeaking pet toy of claim 1 wherein an out outer encasement may be comprised of a plush-type fabric in the shape of an animal.
